(19) United States
(12) Patent Application Publication
(10) Pub. No.: US 2005/0061372 A1
(43) Pub. Date: Mar. 24, 2005

(54) Pressure regulator assembly

(76) Inventors: Dennis P. McGrath, Ortonville, MI (US); Partab Jeswani, Grand Blanc, MI (US); Robert A. Roth, El Paso, TX (US); Philip Moore Anderson, Davison, MI (US)

Correspondence Address: JIMMY L. FUNKE;DELPHI TECHNOLOGIES, INC., Legal Staff, Mail Code: 480-410-202, P.O. Box 5052, Troy, MI, 48007-5052, US

(21) Appl. No.: 10/932,763

(22) Filed: Sep. 2, 2004

Related U.S. Application Data
(63) Continuation-in-part of application No. 10/688,235, filed on Oct. 17, 2003.
(60) Provisional application No. 60/505,178, filed on Sep. 23, 2003.

(51) Int. Cl. F16K 15/04

(52) U.S. Cl. 137/539.5

(57) ABSTRACT

A pressure regulator assembly for a fluid system includes a housing having at least one cavity therein and a valve seat disposed in the at least one cavity and having an aperture extending therethrough. The pressure regulator assembly also includes a movable valve member disposed in the at least one cavity of the housing. The valve member has a closed position to engage the valve seat to prevent fluid from flowing into the at least one cavity and an open position to disengage the valve seat to allow fluid to flow into the at least one cavity. The pressure regulator assembly further includes a biasing mechanism disposed in the at least one cavity to bias the valve member toward the valve seat to close the aperture. The valve seat and the valve member and the biasing mechanism are aligned linearly along an axis of the valve housing.

### CROSS-REFERENCE TO RELATED APPLICATION(S)

The present invention claims the priority date of copending U.S. Provisional Patent Application Ser. No. 60/505,178, filed Sep. 23, 2003 and is a continuation-in-part of copending U.S. patent application Ser. No. 10/688,235, filed Oct. 17, 2003.

### TECHNICAL FIELD

The present invention relates generally to pressure regulators and, more particularly, to a pressure regulator assembly for a fuel system of a vehicle.

### BACKGROUND OF THE INVENTION

It is known to provide a fuel tank in a vehicle to hold fuel to be used by an engine of the vehicle. It is also known to provide a fuel pump inside the fuel tank to pump fuel to the engine and a fuel pressure regulator fluidly connected to the fuel pump to regulate the pressure of the fuel to the engine. Typically, the fuel pressure regulator includes an elastomeric diaphragm, a precision machined metal valve seat, a heavy rate spring, and a mating valve cooperating with the valve seat to check pressure. However, these fuel pressure regulators generally contain between fifteen (15) and twenty (20) separate components. Also, these fuel pressure regulators are relatively costly and are subject to fuel pressure regulation shift due to aging of the elastomeric diaphragm as well as degradation from exposure to alcohol fuels.

It is also known to provide a fuel pressure regulator that does not use an elastomeric diaphragm. This particular fuel pressure regulator overcomes the disadvantages associated with elastomeric diaphragms, but has relatively high pressure regulation gain. Also, the fuel pressure regulator has poor gain control when compared to existing elastomeric diaphragm pressure regulators. Further, the fuel pressure regulator may use a leaf spring construction, making the regulator non-linear in construction and non-interchangeable with existing diaphragm type pressure regulators.

It is, therefore, desirable to provide a new pressure regulator assembly for a fuel system of a vehicle. It is also desirable to provide a pressure regulator assembly that uses no elastomeric materials. It is further desirable to provide a pressure regulator assembly that requires fewer component parts. It is still further desirable to provide a pressure regulator assembly that improves upon the poor gain control of non-elastomeric diaphragm pressure regulators. Therefore, there is a need in the art to provide a pressure regulator assembly for a fuel system that meets these desires.

### SUMMARY OF THE INVENTION

Accordingly, the present invention is a pressure regulator assembly for a fluid system including a housing having at least one cavity therein and a valve seat disposed in the at least one cavity and having an aperture extending therethrough. The pressure regulator assembly also includes a movable valve member disposed in the at least one cavity of the housing. The valve member has a closed position to engage the valve seat to prevent fluid from flowing into the at least one cavity and an open position to disengage the valve seat to allow fluid to flow into the at least one cavity. The pressure regulator assembly further includes a biasing mechanism disposed in the at least one cavity to bias the valve member toward the valve seat to close the aperture. The valve seat and the valve member and the biasing mechanism are aligned linearly along an axis of the valve housing.

One advantage of the present invention is that a new pressure regulator assembly is provided for a fuel system of a vehicle. Another advantage of the present invention is that the pressure regulator assembly provides a nearly constant fluid pressure over a wide range of flows. Yet another advantage of the present invention is that the pressure regulator assembly uses no elastomeric materials. Still another advantage of the present invention is that the pressure regulator assembly reduces the number of components over conventional fuel pressure regulators. A further advantage of the present invention is that the pressure regulator assembly is interchangeable with existing diaphragm type pressure regulators. Yet a further advantage of the present invention is that the pressure regulator assembly could be applied to other fluid systems such as a lubrication system. Still a further advantage of the present invention is that the pressure regulator assembly has a relatively lower cost and robustness to pressure control shift caused by aging or chemical attack of an elastomeric diaphragm. Another advantage of the present invention is that the pressure regulator assembly improves upon the poor gain control of non-elastomeric pressure regulators.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a diagrammatic view of a pressure regulator assembly, according to the present invention, illustrated in operational relationship with a fluid system.

FIG. 2 is an outlet perspective view of the pressure regulator assembly of FIG. 1.

FIG. 3 is an inlet perspective view of the pressure regulator assembly of FIG. 1.

FIG. 4 is a sectional view taken along line 4-4 of FIG. 2 illustrating the pressure regulator assembly in a closed condition.

FIG. 5 is a view similar to FIG. 4 illustrating the pressure regulator assembly in an open condition.

FIG. 6 is a fragmentary elevational view of another embodiment, according to the present invention, of the pressure regulator assembly of FIG. 1.

FIG. 7 is a perspective view of a spring of the pressure regulator assembly of FIG. 6.

### DESCRIPTION OF THE PREFERRED EMBODIMENT

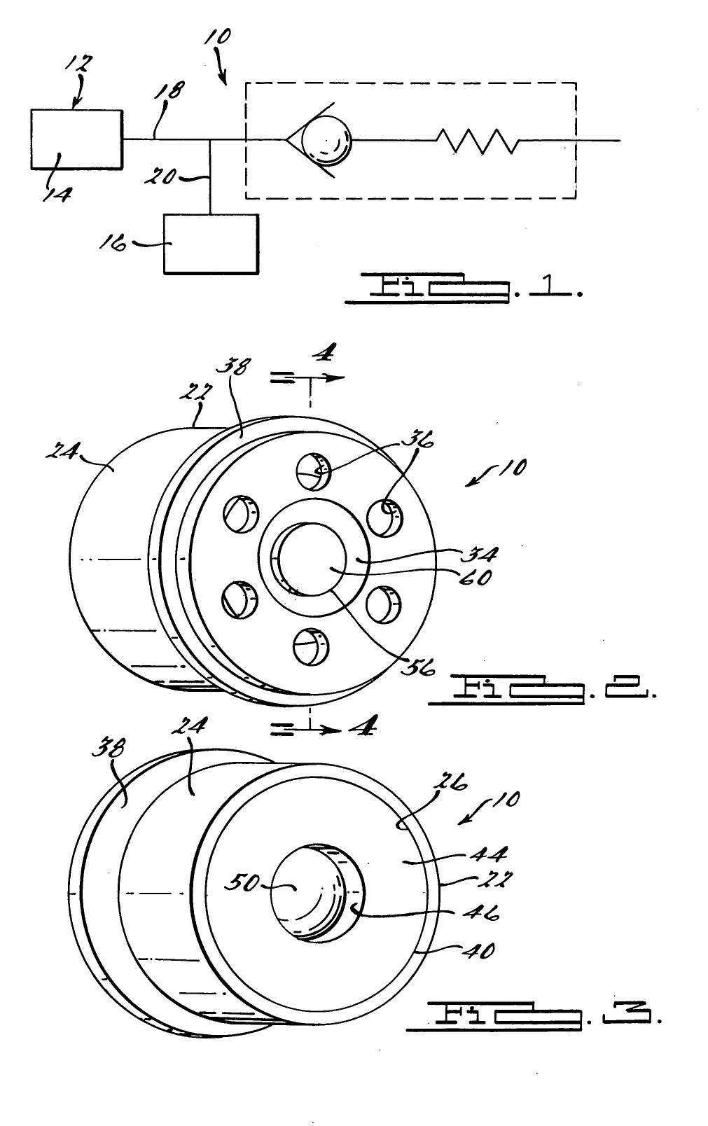

Referring to the drawings and in particular FIG. 1, one embodiment of a pressure regulator assembly 10, according to the present invention, for a fluid system, generally indicated at 12, is shown. The fluid system 12 may be a fuel system of a vehicle (not shown). The fluid system 12 includes a fluid pumping device 14 such as a fuel pump and a system 16 such as an engine. The fluid system 12 includes a first fluid inlet line 18 fluidly connecting the pressure regulator assembly 10 to the fluid pumping device 14 and a second fluid inlet line 20 fluidly connecting the first fluid inlet line 18 to the system 16. It should be appreciated that the pressure regulator assembly 10 regulates the pressure of the fluid from the fluid pumping device 14 to the system 16. It should also be appreciated that the fluid system 12 may be of a hydraulic type requiring a nearly constant fluid pressure maintained over a wide range of flows such as a lubrication system. It should further be appreciated that, except for the pressure regulator assembly 10, the fluid system 12 is conventional and known in the art.

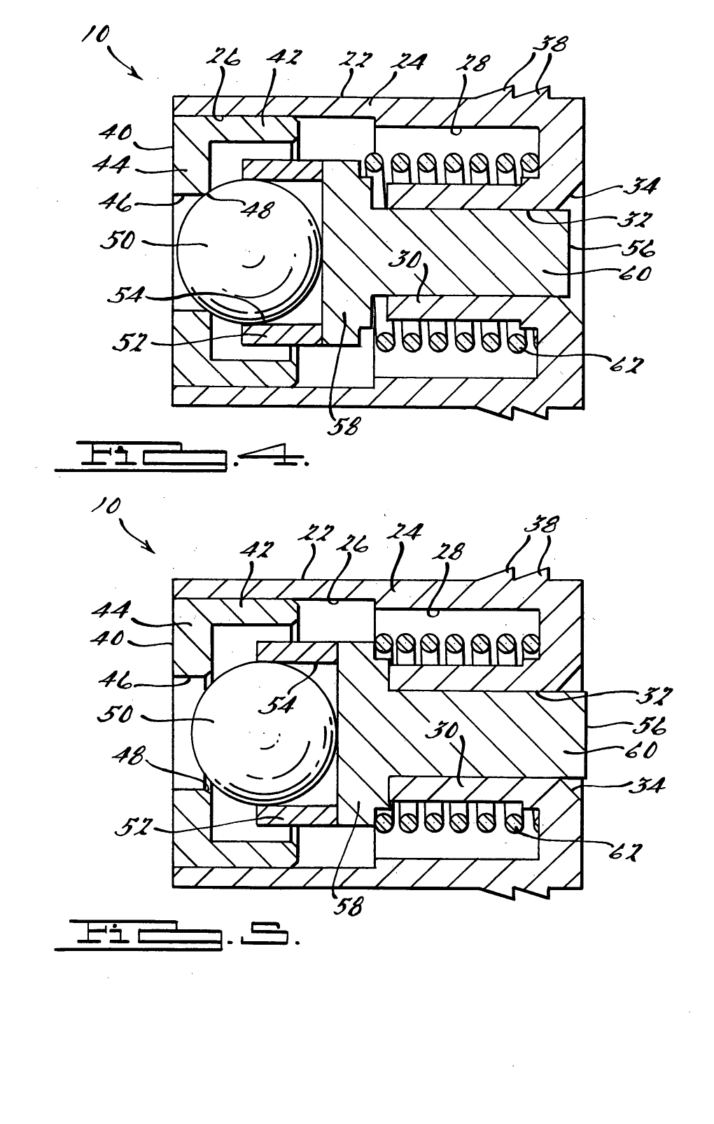

Referring to FIGS. 2 through 4, the pressure regulator assembly 10 includes a valve housing 22 extending axially. The housing 22 has a body portion 24 extending axially that is generally cylindrical in shape and has a generally circular cross-sectional shape. The housing 22 has a first cavity 26 extending axially inward into the body portion 24 and a second cavity 28 extending axially inward into the body portion 24 from the first cavity 26. The second cavity 28 has a diameter less than the first cavity 26.

The housing 22 includes a guide portion 30 extending axially into the second cavity 28 from one end of the body portion 24. The guide portion 30 has a passageway 32 extending axially therethrough for a function to be described. The passageway 32 has a generally circular cross-sectional shape. The passageway 32 includes an enlarged opening 34 at one end thereof. The housing 22 includes at least one, preferably a plurality of fluid outlets 36 spaced circumferentially about the enlarged opening 34 and extending axially through a closed end of the body portion 24. The fluid outlets 36 fluidly communicate with the second cavity 28. The housing 22 may include at least one, preferably a plurality of barbs 38 spaced axially and extending circumferentially about the body portion 24 for connection to the first fluid inlet line 18. The body portion 24 and guide portion 30 are made of a rigid material such as metal. It should be appreciated that the housing 22 is a monolithic structure being integral, unitary, and one-piece.

The pressure regulator assembly 10 includes a valve seat 40 disposed in the first cavity 26 at the other end of the housing 22 and spaced axially from the guide portion 30 of the housing 22. The seat 40 has a generally “C” cross-sectional shape. The seat 40 has a body portion 42 that is generally cylindrical in shape with a generally circular cross-sectional shape. The seat 40 also has a seat portion 44 extending radially from the body portion 42. The seat 40 also has an aperture 46 extending axially through the seat portion 44 to form an inlet. The seat 40 has a chamfer 48 at one end of the aperture 46 for a function to be described. The seat 40 is made of a rigid material such as metal. It should be appreciated that the seat 40 is secured to the body portion 24 of the housing 22 by a suitable mechanism such as press-fitting.

The pressure regulator assembly 10 also includes a valve member 50 disposed in the first cavity 26 and cooperating with the seat 40. The valve member 50 is of a ball type having a generally spherical shape. The valve member 50 extends into the aperture 46 of the seat 40 and engages the chamfer 48 in a closed position. It should be appreciated that, to reduce the non-linear performance at lower fluid flows, the interface between the valve member 50 and seat 40 may utilize either a square seat or an extremely small chamfer that approaches a square seat, thereby greatly reducing the amount of gain produced by the pressure regulator assembly 10.

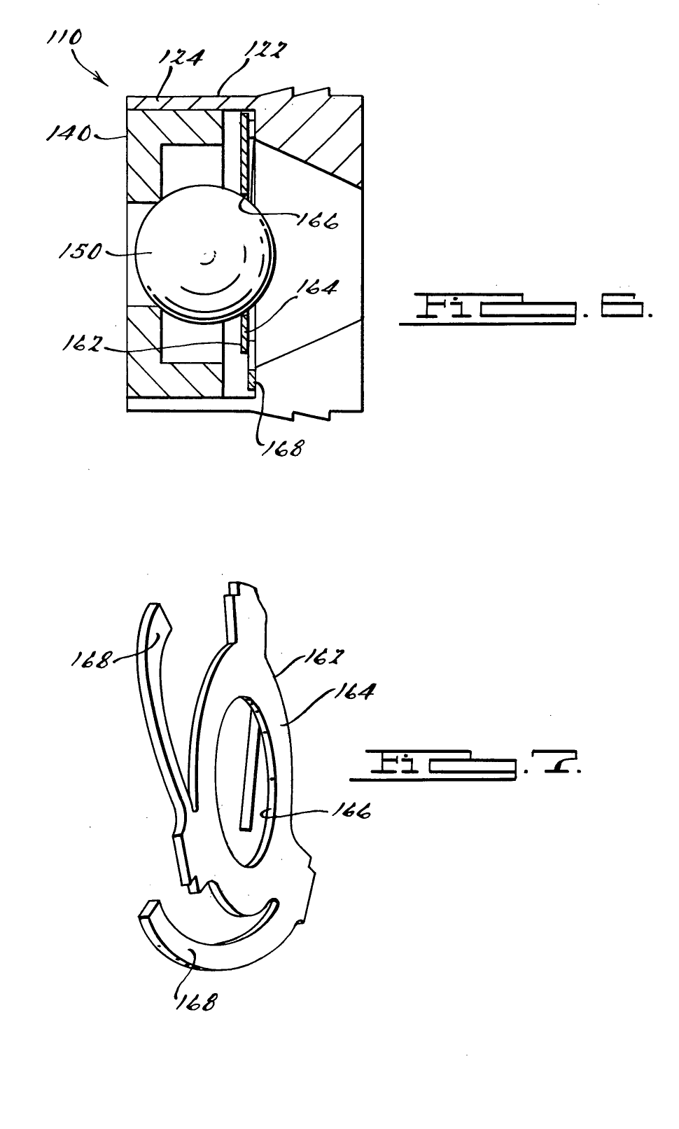

The valve member 50 is made of a rigid material such as metal. The valve member 50 has a first or closed position engaging the seat 40 to close the aperture 46 of the seat 40 as illustrated in FIG. 4. The valve member 50 has a second or open position to open the aperture 46 in the seat 40 as illustrated in FIG. 5. It should be appreciated that fluid such as fuel flows through the aperture 46 in the seat 40, past the valve member 50 and into the first cavity 26 and second cavity 28 and through the fluid outlets 36 when the valve member 50 is in the open position as illustrated in FIG. 5.

The pressure regulator assembly 10 includes a sleeve 52 to hold the valve member 50. The sleeve 52 is generally cylindrical in shape and has a generally circular cross-sectional shape. The sleeve 52 has an aperture 54 extending axially therethrough. The valve member 50 extends into the aperture 54 of the sleeve and is held therein. The sleeve 52 is made of a rigid material such as metal. It should be appreciated that a lift generating/gain reducing geometry is integrated into the valve member 50 and sleeve 52 in contact with the fluid flow stream, and using Computational Fluid Dynamics (CFD), can be tailored to produce a desired gain curve. It should also be appreciated that it is typically desired to have a flat gain curve or a positive gain curve with a slope of less than 0.5 kPa/g/s, thereby causing very little pressure shift over a wide range of flows.

The pressure regulator assembly 10 also includes a poppet 56 disposed in the housing 22 to cooperate with the sleeve 52 to transmit a spring force to be described to the sleeve 52 and the valve member 50. The poppet 56 has a head portion 58 extending radially and a shaft portion 60 extending axially from the head portion 58. The head portion 58 is generally circular in cross-sectional shape. The head portion 58 has a diameter greater than a diameter of the shaft portion 60 to abut the sleeve 52. The shaft portion 60 is generally cylindrical with a generally circular cross-sectional shape. The shaft portion 60 is disposed in the passageway 32 of the guide portion 30 for sliding movement therein. The shaft portion 60 has a length to diameter ratio greater than a predetermined amount such as four (4) to provide balance between valve length and shaft diameter, resulting in better stability and/or reduction of wobble/rattle in the fluid stream. It should be appreciated that the interface between the poppet 56 and sleeve 52 can have respective surface finishes adjusted to optimize performance including allowing the valve member 50 to move enough to center itself in the seat opening on vehicle shut-down which allows fuel line pressure checking, but resist radial movement during operation which could cause oscillation of the valve member 50 and objectionable noise.

The pressure regulator assembly 10 further includes a biasing mechanism such as a spring 62 to urge the valve member 50 toward the seat 40. In one embodiment, the spring 62 is of a coil type. The spring 62 is disposed about the poppet 56 between the head portion 58 and the closed end of the body portion 24 of the housing 22. It should be appreciated that the spring 62 urges the poppet 56 and sleeve 52 toward the seat 40 such that the valve member 50 engages the chamfer 48 of the seat 40 in a closed position as illustrated in FIG. 4. It should also be appreciated that the spring 62 is conventional and known in the art.

In operation of the pressure regulator assembly 10, the valve member 50 engages the seat 40 to close the aperture 46 in the closed position as illustrated in FIG. 4. The valve member 50 is contained on the seat 40 by the spring force of the spring 62. Fluid such as fuel is pumped by the fluid pumping device 14 through the fluid inlet line 18 into the fluid system 12 to the system 16 and to the inlet of the pressure regulator assembly 10. In normal operating conditions where the flow of the fluid is greater than a predetermined amount to the pressure regulator assembly 10, fluid flows to the aperture 46 in the seat 40 and causes the valve member 50 to move from the chamfer 48 in the seat 40. The valve member 50 moves to an open position, which is the maximum position desired off of the seat 40 as illustrated in FIG. 5. In the open position, the valve member 50 allows fluid to flow through the aperture 46 and around the valve member 50 and sleeve 52 in the first cavity 26 and past the poppet 56 in the second cavity 28 through the fluid outlets 36 of the housing 22. Fuel flows from the pressure regulator assembly 10 to a fluid bypass discharge (not shown). In the open position, the valve member 50 is contained and retained in the center of the fuel flow stream by the sleeve 52 and poppet 56, which guides the valve member 50. At low flow conditions, the position of the valve member 50 is determined by the spring rate of the spring 62 and distance of the valve member 50 off of the seat 40. It should be appreciated that the pressure regulator assembly 10 has a linear construction as all component parts, including the poppet 56 and spring 62, are aligned along a common axis or centerline which runs longitudinally or axially through the housing 22. It should also be appreciated that the bias of the spring 62 determines the pressure at which the pressure regulator assembly 10 will operate.

Referring to FIGS. 6 and 7, another embodiment, according to the present invention, of the pressure regulator assembly 10 is shown. Like parts of the pressure regulator assembly 10 have like reference numerals increased by one hundred (100). In this embodiment, the pressure regulator assembly 110 includes the housing 122, seat 140, valve member 150, and spring 162. The spring 162 is of a disc type. The spring 162 has a seat portion 164 extending radially with an aperture 166 extending axially therethrough. The spring 162 also has at least one, preferably a plurality of legs 168 extending axially and circumferentially from the seat portion 164 to allow the seat portion 164 to deflect. The spring 162 is retained by the housing 122 such that the legs 168 engage the body portion 124. The valve member 150 is seated in the aperture 166 of the spring 162. The spring 162 provides radial alignment interface to prevent oscillations of the valve member 150. The operation of the pressure regulator assembly 110 is similar to the pressure regulator assembly 10. It should be appreciated that the pressure regulator assembly 110 eliminates the sleeve and poppet. It should also be appreciated that the spring 162 provides the function performed by the lift generating geometry, eliminating the sleeve. It should further be appreciated that the housing 122 is shorter, which is desirable for packaging.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A pressure regulator assembly for a fluid system comprising:
a housing having at least one cavity therein;
a valve seat disposed in said at least one cavity and having an aperture extending therethrough;
a movable valve member disposed in said at least one cavity of said housing, said valve member having a closed position to engage said valve seat to prevent fluid from flowing into said at least one cavity and an open position to disengage said valve seat to allow fluid to flow into said at least one cavity; and
a biasing mechanism disposed in said at least one cavity to bias said valve member toward said valve seat to close said aperture, said valve seat and said valve member and said biasing mechanism being aligned linearly along an axis of said housing.

2. A pressure regulator assembly as set forth in claim 1 wherein said biasing mechanism comprises a spring to provide a spring force.

3. A pressure regulator assembly as set forth in claim 2 wherein said spring comprises a coil spring.

4. A pressure regulator assembly as set forth in claim 2 wherein said spring comprises a disc spring.

5. A pressure regulator assembly as set forth in claim 1 wherein said valve member comprises a ball.

6. A pressure regulator assembly as set forth in claim 5 including a sleeve disposed in said at least one cavity to hold said ball.

7. A pressure regulator assembly as set forth in claim 6 including a poppet disposed in said housing and cooperating with said sleeve and said biasing mechanism.

8. A pressure regulator assembly as set forth in claim 1 wherein said valve seat includes a chamfer at one end of said aperture for contact with said valve member in the closed position.

9. A pressure regulator assembly as set forth in claim 1 wherein said housing includes at least one fluid outlet communicating with said at least one cavity.

10. A pressure regulator assembly as set forth in claim 1 including a valve guide disposed in said housing.

11. A pressure regulator assembly for a fuel system of a vehicle comprising:
a valve housing extending axially;
a valve guide disposed in said valve housing;
a valve seat disposed within said valve housing and spaced from said valve guide; and
a movable valve member disposed in said at least one cavity of said valve housing, said valve member having a closed position to engage said valve seat to prevent fluid from flowing into said at least one cavity and an open position to disengage said valve seat to allow fluid to flow into said at least one cavity; and
a biasing mechanism disposed in said at least one cavity to bias said valve member toward said valve seat to close said aperture, said valve seat and said valve member and said biasing mechanism being aligned linearly along an axis of said valve housing.

12. A pressure regulator assembly as set forth in claim 11 wherein said biasing mechanism comprises a spring to provide a spring force.

13. A pressure regulator assembly as set forth in claim 12 wherein said spring comprises a coil spring.

14. A pressure regulator assembly as set forth in claim 12 wherein said spring comprises a disc spring.

15. A pressure regulator assembly as set forth in claim 11 wherein said valve member comprises a ball.

16. A pressure regulator assembly as set forth in claim 15 including a sleeve disposed in said at least one cavity to hold said ball.

17. A pressure regulator assembly as set forth in claim 16 including a poppet disposed in said valve housing and cooperating with said sleeve and said biasing mechanism.

18. A pressure regulator assembly as set forth in claim 11 wherein said valve seat includes a chamfer at one end of said aperture for contact with said valve member in the closed position.

19. A pressure regulator assembly as set forth in claim 11 wherein said valve housing includes at least one fluid outlet communicating with said at least one cavity.

20. A vehicle comprising:
an engine;
a fuel pump to pump fuel to said engine; and
a fuel pressure regulator assembly fluidly connected to said fuel pump to regulate pressure of the fuel to said engine, said fuel pressure regulator assembly comprising a housing having at least one cavity therein, a valve seat disposed in said at least one cavity and having an aperture extending therethrough, a movable valve member disposed in said at least one cavity of said housing, said valve member having a closed position to engage said valve seat to prevent fluid from flowing into said at least one cavity and an open position to disengage said valve seat to allow fluid to flow into said at least one cavity, a biasing mechanism disposed in said at least one cavity to bias said valve member toward said valve seat to close said aperture, and said valve seat and said valve member and said biasing mechanism being aligned linearly along an axis of said housing.
